(19) United States
(12) Patent Application Publication
(10) Pub. No.: US 2017/0175653 A1
(43) Pub. Date: Jun. 22, 2017

(54) FUEL INJECTION CONTROLLER FOR INTERNAL COMBUSTION ENGINE

(71) Applicant: TOYOTA JIDOSHA KABUSHIKI KAISHA, Toyota-shi, Aichi-ken (JP)

(72) Inventors: Daisuke UCHIDA, Gotenba-shi, Shizuoka-ken (JP); Motonari YARINO, Sunto-gun, Shizuoka-ken (JP)

(73) Assignee: TOYOTA JIDOSHA KABUSHIKI KAISHA, Toyota-shi, Aichi-ken (JP)

(21) Appl. No.: 15/115,731

(22) PCT Filed: Jan. 16, 2015
(86) PCT No.: PCT/IB2015/000036

§ 371 Date: Aug. 1, 2016

(30) Foreign Application Priority Data
Feb. 3, 2014 (JP) 2014-018621

(51) Int. Cl. F02D 41/00; F02D 41/40

(52) U.S. Cl. CPC F02D 41/0002; F02D 41/402; F02D 2041/0015

(57) ABSTRACT

A fuel injection controller for an internal combustion engine is provided. The fuel injection controller includes an electronic control unit configured to (a) execute main fuel injection and auxiliary fuel injection in one engine cycle; and (b) execute the auxiliary fuel injection at least once in a particular period that includes timing at which a intake valve starts opening, so that fuel injected in the auxiliary fuel injection is carried by a reverse tumble stream, the reverse tumble stream being an air stream that flows from a intake port into a combustion chamber, flows along a bore wall surface on the intake valve side that is on an opposite side from a exhaust valve toward a piston crown surface, and then flows from the piston crown surface toward a cylinder head lower surface.

### BACKGROUND OF THE INVENTION

1. Field of the Invention

The present invention relates to a fuel injection controller that includes a fuel injection valve for directly injecting fuel into a combustion chamber (into a cylinder) and that is applied to an internal combustion engine.

2. Description of Related Art

Japanese Patent Application Publication No. 2001-73819 (JP 2001-73819 A) discloses an internal combustion engine that includes a fuel injection valve for directly injecting fuel into a combustion chamber. In this internal combustion engine, valve timing is set such that an opening period of an intake valve does not overlap an opening period of an exhaust valve and that the intake valve starts opening after an intake top dead center during homogenous lean operation. According to the above, the intake valve starts opening after a piston starts descending from the intake top dead center and negative pressure is generated in the combustion chamber. Thus, the air flows into the combustion chamber at a high flow velocity immediately after the intake valve starts opening. Furthermore, in this combustion chamber, the fuel is continuously injected from a point in time immediately before the intake valve starts opening through a point in time immediately after the intake valve starts opening. As a result, since the injected fuel can be dispersed by the air that flows into the combustion chamber at the high flow velocity, air-fuel mixture with high homogeneity can be generated in the combustion chamber. Noted that in this internal combustion engine, the fuel injection valve is disposed such that the fuel is injected from a position that is in the vicinity of the intake valve and also is in the vicinity of a bore wall surface toward the center of the combustion chamber.

### SUMMARY OF THE INVENTION

In the above conventional internal combustion engine, the fuel injection with a high penetrating force is executed from “a point in time immediately before the intake valve starts opening”, at which an air stream is not generated in the combustion chamber. Thus, there is a possibility that the injected fuel is adhered to the bore wall surface on the exhaust valve side and, as a result, an emission is deteriorated.

The present invention provides a fuel injection controller that is applied to an internal combustion engine including a fuel injection valve for directly injecting fuel into a combustion chamber and that can generate air-fuel mixture with high homogeneity by executing appropriate fuel injection.

A fuel injection controller for an internal combustion engine according to one aspect of the present invention is provided. The internal combustion engine includes a combustion chamber, an intake valve, an exhaust valve, and a fuel injection valve. The combustion chamber is defined by a piston crown surface, a cylinder head lower surface that faces the piston crown surface, and a cylinder bore. The intake valve is configured to open or close a intake communicating section between the combustion chamber and an intake port. The intake communicating section is arranged below the cylinder head lower surface. The exhaust valve is configured to open or close a exhaust communicating section between the combustion chamber and an exhaust port. The exhaust communicating section is arranged below the cylinder head lower surface. The fuel injection valve is configured to inject fuel from a specified position in a region near a wall surface of the cylinder bore on the intake valve side to a region between the exhaust valve and the piston crown surface in the combustion chamber. The intake port is configured to generate a normal tumble stream and a reverse tumble stream in an opening period of the intake valve. The normal tumble stream is an air stream that flows from the intake port into the combustion chamber, flows toward the region in the vicinity of the exhaust valve, further flows along the wall surface of the cylinder bore on the exhaust valve side toward the piston crown surface, and then flows from the piston crown surface toward the cylinder head lower surface. The reverse tumble stream is an air stream that flows from the intake port into the combustion chamber, flows along the wall surface of the cylinder bore on the intake valve side toward the piston crown surface, and then flows from the piston crown surface toward the cylinder head lower surface. The fuel injection controller includes an electronic control unit (ECU). The ECU configured to: (a) execute main fuel injection and auxiliary fuel injection in one engine cycle, a lift amount of a needle valve in the fuel injection valve is changed in a range up to a first lift amount in the main fuel injection, the lift amount of the needle valve is changed in a range up to a second lift amount that is smaller than the first lift amount in the auxiliary fuel injection; and (b) execute the auxiliary fuel injection at least once in a particular period that includes timing at which the intake valve starts opening, so that fuel injected in the auxiliary fuel injection is carried by the reverse tumble stream.

Furthermore, in the above aspect, the ECU may be configured to set the particular period within a period between a first point in time and a second point in time. The first point in time is timing at which the intake valve starts opening. The second point in time is timing at which the lift amount of the intake valve reaches the maximum lift amount of the intake valve. The particular period includes an intermediate point in time between the first point in time and the second point in time.

In the above aspect, the auxiliary fuel injection is executed in such timing that the injected fuel in the auxiliary fuel injection (that is, the fuel that is injected when the lift amount of the needle valve is changed in the range up to the second lift amount) is carried by the reverse tumble stream (that is, in the particular period). The injected fuel in this auxiliary fuel injection has a small penetrating force. Accordingly, for example, in the case where the auxiliary fuel injection is executed before opening of the intake valve, the intake valve is opened in a state that the injected fuel remains in the region in the vicinity of the intake valve. Thus, the injected fuel is carried and dispersed by the reverse tumble stream that is generated along the bore wall surface on the intake valve side. Alternatively, even when the auxiliary fuel injection is executed after the opening of the intake valve, the injected fuel is carried and dispersed by the reverse tumble stream that has already been generated. As a result, the fuel that is injected in the auxiliary fuel injection is not substantially adhered to the bore wall surface, and thus is favorably dispersed in the combustion chamber.

By the way, in general, a velocity (can also be said as intensity) of the reverse tumble stream becomes the highest at substantially intermediate timing between “the point in time at which the intake valve starts opening (the first point in time)” and “the point in time at which the lift amount of the intake valve reaches the maximum lift amount of the intake valve (the second point in time)”. Accordingly, it is preferred that the ECU sets “the specified period that is from the first point in time at which the intake valve starts opening to the second point in time at which the lift amount of the intake valve reaches the maximum lift amount of the intake valve and that includes the intermediate point in time between the first point in time and the second point in time” as the particular period. In this way, since the injected fuel in the auxiliary fuel injection can be carried by the further intense reverse tumble stream, the injected fuel can favorably be dispersed in the combustion chamber.

In the above aspect, the ECU may be configured to set the particular period such that the fuel injected in the auxiliary fuel injection is carried by the reverse tumble stream that is generated in a reverse tumble period in which an initial velocity of the reverse tumble stream is higher than an initial velocity of the normal tumble stream. Furthermore, the ECU may be configured to execute the main fuel injection in a period that is after the reverse tumble period and in which the initial velocity of the reverse tumble stream is equal to or lower than the initial velocity of the normal tumble stream.

According to this aspect, the auxiliary fuel injection is executed in the reverse tumble period in which the initial velocity of the reverse tumble stream (that is, the velocity of the reverse tumble stream immediately after the air flows from the intake port into the combustion chamber) is higher than the initial velocity of the normal tumble stream (that is, the velocity of the normal tumble stream immediately after the air flows from the intake port into the combustion chamber). Accordingly, the injected fuel in the auxiliary fuel injection is dispersed in the combustion chamber by the reverse tumble stream. Furthermore, according to this aspect, the main fuel injection is executed after the reverse tumble period (that is, in the period in which the initial velocity of the normal tumble stream is higher than the initial velocity of the reverse tumble stream). Since the injected fuel in this main fuel injection has the large penetrating force, the injected fuel may reach the vicinity of the bore wall surface on the exhaust valve side. However, since the main fuel injection is executed in the period in which the normal tumble stream is intense, a large amount of the injected fuel in the main fuel injection is not adhered to the bore wall surface on the exhaust valve side, and the injected fuel is carried by the normal tumble stream and dispersed in the combustion chamber. As a result, according to the above aspect, air-fuel mixture with high homogeneity can be generated in the entire combustion chamber due to both of the dispersion of the fuel by the reverse tumble stream and the dispersion of the fuel by the normal tumble stream.

Furthermore, an increased amount of the fuel is dispersed by the reverse tumble stream when the number of execution of the auxiliary fuel injection is increased. Accordingly, the ECU may be configured to execute the auxiliary fuel injection for plural times. In this way, the air-fuel mixture with high homogeneity is further generated in the cylinder.

When an engine speed is low, a velocity of an air stream in the combustion chamber (that is, an air stream that is generated in the cylinder) is low. Thus, the injected fuel is less likely to be dispersed in comparison with a case of the high engine speed. Accordingly, the ECU may be configured to set the increased number of execution of the auxiliary fuel injection as rotational speed of the internal combustion engine decreases. When an engine load is large, the amount of the injected fuel is large. Thus, the injected fuel is less likely to be dispersed in comparison with a case of the low engine load. Accordingly, the ECU may be configured to set the increased number of execution of the auxiliary fuel injection as load of the internal combustion engine increases. According to these aspects, the air-fuel mixture with high homogeneity can be generated in the combustion chamber even under a situation where the injected fuel is less likely to be dispersed.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic cross-sectional view of an internal combustion engine, to which a fuel injection controller according to embodiments of the present invention is applied;

FIG. 2 shows conditions of air streams (in-cylinder air streams) that are generated in a combustion chamber when an intake valve is opened;

FIG. 3 is a cross-sectional view of a fuel injection valve that is shown in FIG. 1;

FIG. 4A shows a condition of an in-cylinder air stream in an initial stage of opening of the intake valve;

FIG. 4B shows a condition of the in-cylinder air stream in an intermediate stage of opening of the intake valve;

FIG. 5A is a graph of a relationship between a crank angle and a lift amount of the intake valve;

FIG. 5B is a graph of a relationship between the crank angle and tumble streams (a normal tumble stream and a reverse tumble stream);

FIG. 6A is a graph of a time change of a needle lift amount in full lift injection;

FIG. 6B is a graph of a time change of the needle lift amount in partial lift injection;

FIG. 7A is a cross-sectional view of a tip portion of the fuel injection valve during the full lift injection;

FIG. 7B is a cross-sectional view of the tip portion of the fuel injection valve during the partial lift injection;

FIG. 8A is a view in which spray of fuel that is injected into the combustion chamber is seen along a cylinder center axis;

FIG. 8B is a view in which the spray of the fuel that is injected into the combustion chamber is seen in a specified orthogonal direction to the cylinder center axis;

FIG. 9 is a graph of “a relationship between the crank angle and each of the lift amount of the intake valve, velocity of the reverse tumble stream, and the needle lift amount of the fuel injection valve” in a first embodiment;

FIG. 10 is a flowchart of a fuel injection control flow of the first embodiment;

FIG. 11 is a graph of “the relationship between the crank angle and each of the lift amount of the intake valve, the velocity of the reverse tumble stream, and the needle lift amount of the fuel injection valve” in a second embodiment;

FIG. 12A is a graph of “the relationship between the crank angle and each of the lift amount of the intake valve, the velocity of the reverse tumble stream, and the needle lift amount of the fuel injection valve” when an engine speed is high;

FIG. 12B is a graph of “the relationship between the crank angle and each of the lift amount of the intake valve, the velocity of the reverse tumble stream, and the needle lift amount of the fuel injection valve” when the engine speed is low;

FIG. 13 is a chart of an execution region of auxiliary fuel injection in a third embodiment;

FIG. 14 is a flowchart of the fuel injection control flow of the third embodiment; and

FIG. 15 is a lookup table to which an electronic control unit in FIG. 1 refers in order to determine the number of execution of the partial lift injection.

### DETAILED DESCRIPTION OF EMBODIMENTS

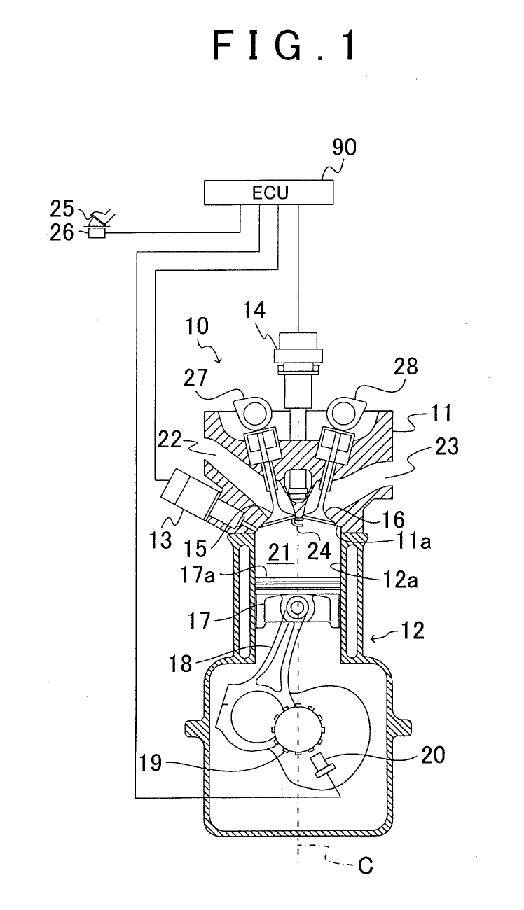

A description will hereinafter be made on a fuel injection controller (hereinafter, simply referred to as “this controller”) according to a first embodiment of the present invention with reference to the drawings. This controller is applied to an internal combustion engine, a body 10 of which is shown in FIG. 1. The body 10 includes a cylinder head 11, a cylinder block 12, a fuel injection valve 13, an ignition system 14, an intake valve 15, an exhaust valve 16, a piston 17, a connecting rod 18, a crankshaft 19, and a crank position sensor 20. Hereinafter, a direction in which the piston 17 moves from a bottom dead center to a top dead center is referred to as “above”, and a direction in which the piston 17 moves from the top dead center to the bottom dead center is referred to as “below”. Furthermore, the intake valve 15 side from a cylinder center axis C is referred to as an “intake side”, and the exhaust valve 16 side from the cylinder center axis C is referred to as an “exhaust side”.

A combustion chamber 21 is defined by a lower surface 11a of the cylinder head 11, a bore (cylinder bore) wall surface 12a, and a piston crown surface 17a. The fuel injection valve 13, the ignition system 14, the intake valve 15, and the exhaust valve 16 are attached to the cylinder head 11. The ignition system 14 includes an igniter, an ignition coil, and a spark plug. The cylinder head 11 is formed with an intake port 22 and an exhaust port 23. One end of the intake port 22 communicates with the combustion chamber 21, and another end thereof communicates with an intake manifold (not shown). The intake port 22 is in such a shape that the air flowing from the intake port 22 into the cylinder 21 can generate a normal tumble stream, which will be described below. In other words, the intake port 22 is a so-called normal tumble port. One end of the exhaust port 23 communicates with the combustion chamber 21, and another end thereof communicates with an exhaust manifold (not shown).

The ignition system 14 is disposed in the cylinder head 11 such that, an electrode 24 of the spark plug provided at a tip thereof is positioned substantially above the center of the combustion chamber 21. The intake valve 15 is disposed on the intake side of the cylinder head 11 such that it can move reciprocally. When an intake cam 27 rotates, the intake valve 15 follows a cam nose of the intake cam 27 and moves reciprocally, so as to open or block a intake communicating section between the combustion chamber 21 and the intake port 22. The exhaust valve 16 is disposed on the exhaust side of the cylinder, head 11 such that it can move reciprocally. When an exhaust cam 28 rotates, the exhaust valve 16 follows a cam nose of the exhaust cam 28 and moves reciprocally, so as to open or block a exhaust communicating section between the combustion chamber 21 and the exhaust port 23.

Although not shown, the internal combustion engine 10 shown in FIG. 1 includes two each of the intake valve 15 and the intake port 22 on the intake side, and also includes two each of the exhaust valve 16 and the exhaust port 23 on the exhaust side. In other words, this engine is a well-known four-valve engine. Each of these intake ports 22 is the normal tumble port that can generate the normal tumble stream.

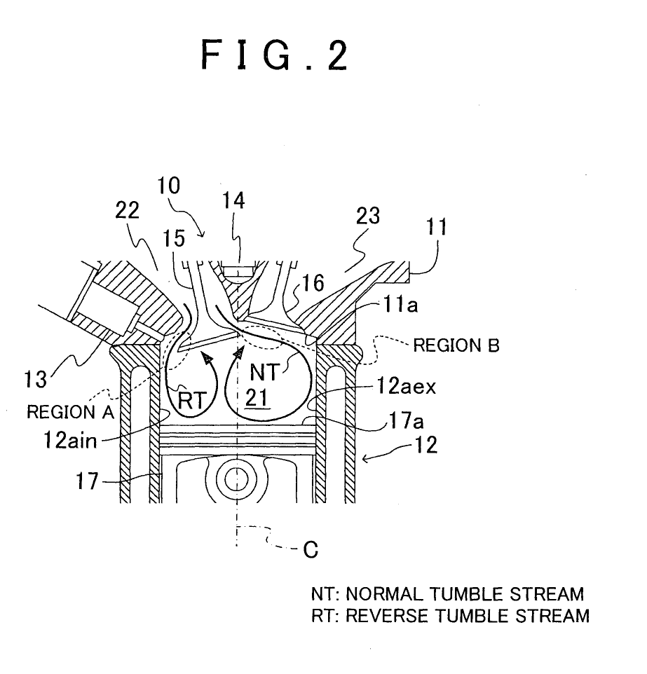

As shown by a curve line NT in FIG. 2, the normal tumble stream indicates an air stream that flows from the intake port 22 into the cylinder 21, flows toward a region B in the vicinity of the exhaust valve 16, further flows along a bore wall surface 12aex on the exhaust valve side toward the piston crown surface 17a, and then flows from the piston crown surface 17a toward the cylinder head lower surface 11a in an opening period of the intake valve 15.

As shown in FIG. 1, the cylinder block 12 includes the piston 17, the connecting rod 18, the crankshaft 19, and the crank position sensor 20.

The fuel injection valve 13, the ignition system 14, the crank position sensor 20, and an accelerator pedal depression amount sensor 26 are electrically connected to an electronic control unit (ECU) 90. The ECU 90 provides control signals for respectively controlling operations of the fuel injection valve 13 and the ignition system 14 to the fuel injection valve 13 and the ignition system 14. The crank position sensor 20 detects a rotational position of the crankshaft 19. The ECU 90 calculates an engine speed, rotational speed of the internal combustion engine, on the basis of a detection signal from the crank position sensor 20. The accelerator pedal depression amount sensor 26 detects a depression amount of an accelerator pedal 25. The ECU 90 calculates an engine load on the basis of information on the depression amount of the accelerator pedal 25 and the like.

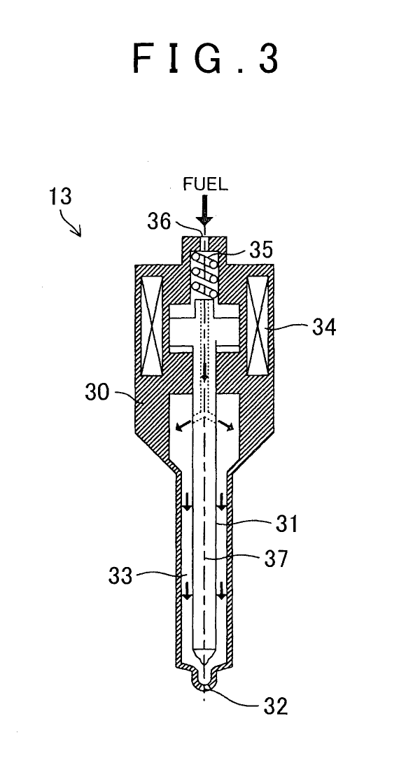

FIG. 3 shows a configuration of the fuel injection valve 13. The fuel injection valve 13 includes a nozzle body 30, a needle valve 31, a fuel injection hole (hereinafter an “injection hole”) 32, a fuel passage 33, a solenoid 34, a spring 35, and a fuel inlet 36. A needle valve axis 37 is an axis that extends in a longitudinal direction of the fuel injection valve 13. The fuel injection valve 13 is a fuel injection valve of so-called interior opening type.

The injection hole 32 of the fuel injection valve 13 is a slit-shaped injection hole. In other words, when the vicinity of a tip of the fuel injection valve 13 is cut by a plane that is perpendicular to an injection axis of the injection hole 32, a cross section of the injection hole 32 is in a rectangular shape. An area of this cross section is gradually increased in a direction from an entry of the injection hole 32 to an exit thereof. Accordingly, when the vicinity of the tip of the fuel injection valve 13 is cut by a plane that includes a longitudinal direction of the rectangular cross section and the injection axis, a cross section of the injection hole 32 is in a fan shape.

As shown in FIG. 2, the fuel injection valve 13 is disposed in a portion, of the engine body 10 on the piston 17 side from the intake port 22 that is formed above the combustion chamber 21 (a portion of the cylinder head 11). In other words, the fuel injection valve 13 is disposed to inject the fuel from a specified position in a region in the vicinity of a bore wall surface 12ain of the intake valve 15 (see a region A) that is on an opposite side from the exhaust valve 16 toward a region in the combustion chamber 21 that is between the exhaust valve 16 and the piston crown surface 17a. Noted that, the fuel injection valve 13 may be disposed at the above-described position in a portion of the cylinder block 12.

Furthermore, the fuel injection valve 13 is disposed such that the injection axis thereof exists on a plane that bisects a straight line for connecting the centers of “the intake communicating sections between the two intake ports 22 and the combustion chambers 21” and that passes through the cylinder center axis C.

In other words, the fuel injection valve 13 is disposed such that the injection axis thereof passes through the center of the cylinder when seen in a direction of the cylinder center axis C. Furthermore, when seen in a direction orthogonal to the plane that includes the injection axis and the cylinder center axis C, the fuel injection valve 13 is disposed such that the injection axis thereof is parallel to the plane orthogonal to the cylinder center axis C or faces diagonally downward from the plane (in a direction toward the piston crown surface 17a and the bore wall surface 12aex on the exhaust valve side).

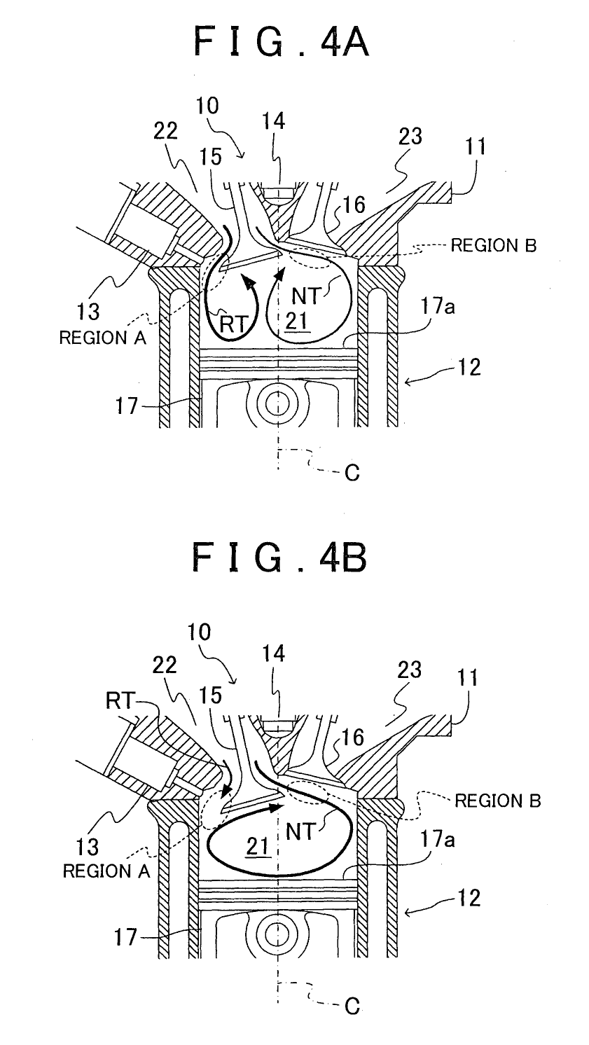

Next, a description will be made on an in-cylinder air stream with reference to FIG. 2, FIG. 4A, and FIG. 4B. The in-cylinder air stream means an air stream that is generated in the combustion chamber 21 (in the cylinder). In a state shown in FIG. 2, the intake valve 15 is opened, and the exhaust valve 16 is completely closed. In this state, a reverse tumble stream RT and the above-described normal tumble stream NT are generated. The reverse tumble stream RT indicates an air stream that flows from the intake port 22 into the combustion chamber 21, flows toward the piston crown surface 17a along the bore wall surface 12ain of the intake valve 15 that is on the opposite side from the exhaust valve 16, and then flows from the piston crown surface 17a toward the cylinder head lower surface 11a.

FIG. 4A shows a condition of the in-cylinder air stream in an initial stage of opening of the intake valve 15. Although the details will be described below, a velocity (an initial velocity) of the reverse tumble stream RT is higher than a velocity (an initial velocity) of the normal tumble stream NT in the initial stage of opening of the intake valve 15 (that is, when a lift amount of the intake valve 15 is small). Accordingly, the strong reverse tumble stream RT is generated in an in-cylinder region on the intake side. Just as described, although the intake port 22 is the normal tumble port, the reverse tumble stream RT is generated in the initial stage of opening of the intake valve 15. Meanwhile, FIG. 4B shows a condition of the in-cylinder air stream in an intermediate stage of opening of the intake valve 15. In the intermediate stage of opening of the intake valve 15 (that is, the lift amount of the intake valve 15 is the substantially maximum lift amount), the velocity (the initial velocity) of the normal tumble stream NT is substantially higher than the velocity (the initial velocity) of the reverse tumble stream RT. Accordingly, the strong normal tumble stream NT is generated in the entire cylinder. Noted that the initial velocity of the reverse tumble stream RT is the velocity of the reverse tumble stream RT at a position immediately after the air passes through “the opposite side of the intake valve 15 from the exhaust valve 16” and flows into the combustion chamber 21 (that is, the region A in FIG. 4A and FIG. 4B). The initial velocity of the normal tumble stream NT is the velocity of the normal tumble stream NT at a position immediately after the air passes through the exhaust valve side of the intake valve 15 and flows into the combustion chamber 21 (that is, the region B in FIG. 4A and FIG. 4B).

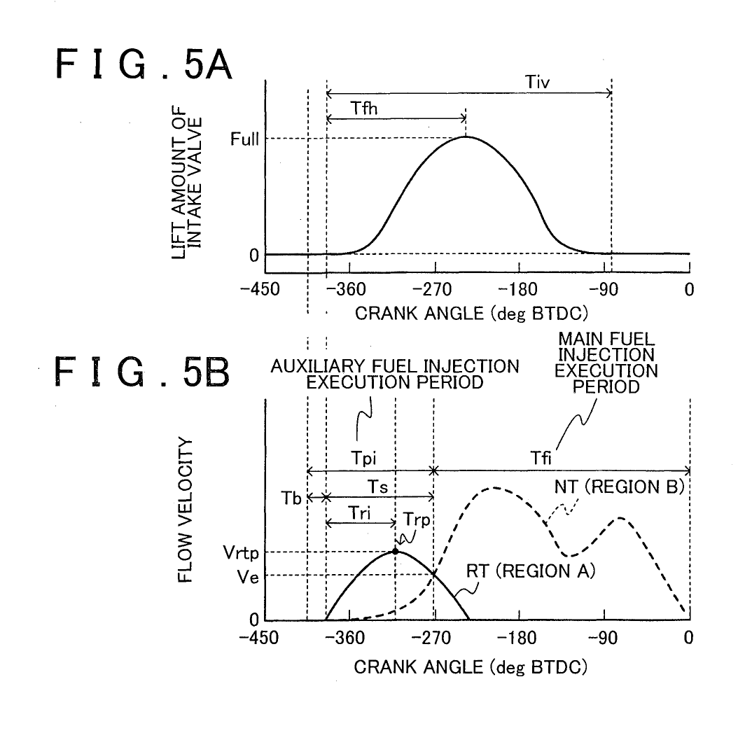

A detailed description will be made on a relationship between the above-described lift amount of the intake valve and the velocity of the in-cylinder air stream with reference to FIG. 5A and FIG. 5B. FIG. 5A and FIG. 5B each show a simulation result about a relationship between a crank angle and the air streams that are generated in the cylinder. In FIG. 5A and FIG. 5B, 0° of the crank angle corresponds to a compression top dead center. As shown in FIG. 5A, the intake valve 15 starts opening immediately before the crank angle becomes −360° (an intake top dead center), and is completely closed slightly before the crank angle becomes −90° (an intermediate point in a compression stroke). The lift amount of the intake valve is gradually increased after the intake valve 15 starts opening, reaches the maximum near the crank angle of −240°, and is then gradually reduced. Noted that the exhaust valve 16 is constantly closed in this simulation.

A curve line that is represented by the solid line RT in FIG. 5B indicates the velocity (an initial velocity Vrt) of the reverse tumble stream RT in the region A of FIG. 2, FIG. 4A, and FIG. 4B. The velocity (the initial velocity) Vrt of the reverse tumble stream RT is relatively abruptly increased after the intake valve 15 starts opening, reaches a maximum velocity Vrtp near the crank angle of −310°, and is then reduced. The velocity (the initial velocity) Vrt of the reverse tumble stream RT becomes zero near the crank angle of −240°.

A curve line that is represented by the chain line NT in FIG. 5B indicates the velocity (an initial velocity Vnt) of the normal tumble stream NT in the region B in of FIG. 2, FIG. 4A, and FIG. 4B. The velocity (the initial velocity) Vnt of the normal tumble stream NT is gradually increased after the intake valve 15 starts opening, reaches the maximum near the crank angle of −210°, and is then reduced.

As shown in FIG. 5B, a period from a point in time at which the intake valve 15 starts opening to a point in time at which the crank angle approximates −270°, the velocity Vrt of the reverse tumble stream RT is higher than the velocity Vnt of the normal tumble stream NT (Vrt>Vnt). Then, near the crank angle of −270°, the velocity Vrt of the reverse tumble stream RT becomes equal to the velocity Vnt of the normal tumble stream NT (Vrt=Vnt=Ve). After that, the velocity Vrt of the reverse tumble stream RT becomes smaller than the velocity Vnt of the normal tumble stream NT (Vrt<Vnt).

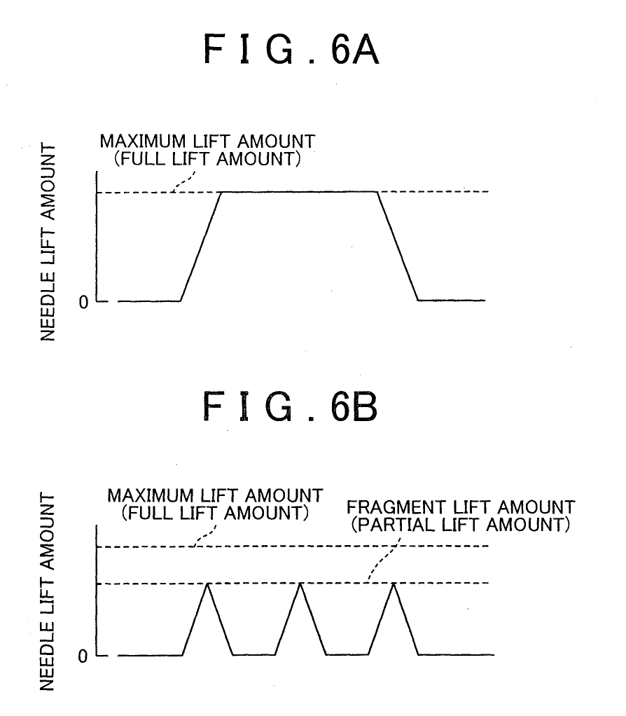

The fuel injection valve 13 can change a needle lift amount (that is, a lift amount of the needle valve 31) by controlling energization time of the solenoid 34 in the fuel injection valve 13. Injection that causes the needle valve 31 to lift for a maximum lift amount (that is, a full lift amount) is referred to as full lift injection. Meanwhile, injection that causes the needle valve 31 to lift in a range in which the needle valve 31 lifts for a fragment lift amount (that is, a partial lift amount) is referred to as partial lift injection, the fragment lift amount being smaller than the full lift amount. FIG. 6A shows a time change of the needle lift amount in the single full lift injection. FIG. 6B shows a time change of the needle lift amount in three times of the partial lift injection.

In main fuel injection, the needle lift amount is changed in a range up to a first lift amount. Although the first lift amount is the maximum lift amount in this example, the first lift amount may be a smaller lift amount than the maximum lift amount. In other words, the main fuel injection is either the full lift injection or the partial lift injection. Meanwhile, in auxiliary fuel injection, the needle lift amount is changed in a range up to a second lift amount. The second lift amount is smaller than the first lift amount. In other words, the auxiliary fuel injection is the partial lift injection in which the lift amount is smaller than the first lift amount.

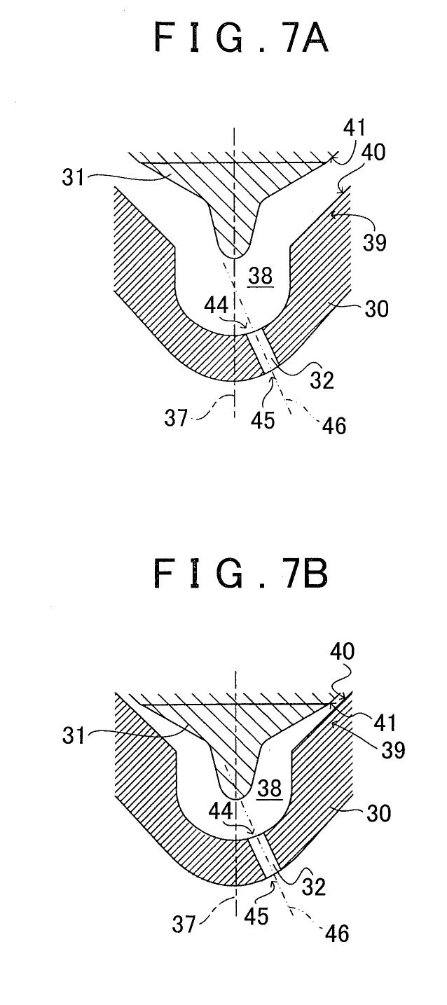

FIG. 7A and FIG. 7B are each a cross-sectional view of a tip of the nozzle body 30 (the vicinity and periphery of the needle valve 31 and the injection hole 32) that is cut along “a plane including the needle valve axis 37 and an injection axis 46”. The injection hole 32 is a passage that connects between an inflow port 44 that is opened to an inner wall of the nozzle body 30 and an outflow port 45 that is opened to an outer wall of the nozzle body 30. A space that is surrounded by the inner wall of the nozzle body 30 and the needle valve 31 is a sack 38. In a state of the full lift injection that is shown in FIG. 7A, a flow passage area between a nozzle seat 40 and a needle seat 41 (that is, an area of an entry of the sack 38) is larger than an injection hole area at the inflow port 44. In other words, the smallest restricted portion in a fuel flow passage is the inflow port 44 of the injection hole 32.

On the other hand, in a state of the partial lift injection that is shown in FIG. 7B, the area of the entry of the sack 38 is smaller than the injection hole area at the inflow port 44. In other words, the smallest restricted portion in the fuel flow passage is the entry of the sack 38. Accordingly, in the state of the partial lift injection in which the area of the entry of the sack 38 is smaller than the injection hole area, a flow velocity of the fuel in a flow passage at the entry of the sack 38 is higher than a flow velocity of the fuel in the inflow port 44 of the injection hole 32.

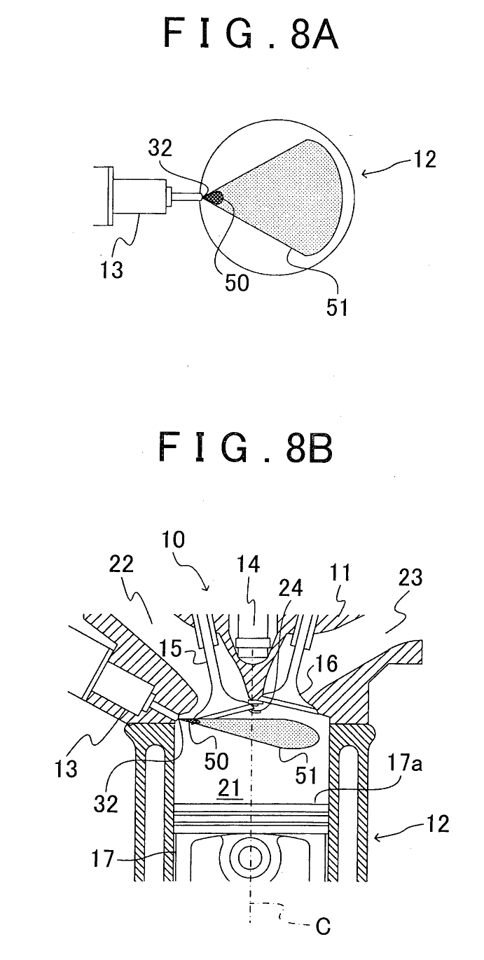

In the partial lift injection, the fuel whose flow velocity is increased in the flow passage at the entry of the sack 38 flows into the sack 38. However, since an area of the flow passage of the sack 38 is larger than an area of the flow passage at the entry of the sack 38 (that is, a volume thereof is large), the velocity and pressure (fuel pressure) of the fuel that has flown into the sack 38 are reduced. A reduction amount of the fuel pressure at this time is larger than a reduction amount of the fuel pressure in the full lift injection. As a result, differential pressure between pressure of the fuel in the injection hole 32 and in-cylinder pressure becomes lower than the differential pressure in the full lift injection. Accordingly, a penetrating force of the fuel that is injected from the injection hole 32 in the partial lift injection is smaller than that in the full lift injection. Furthermore, the opening area of the above smallest restricted portion becomes smaller with the smaller needle lift amount. Accordingly, the fuel pressure in the sack 38 is lowered, and the penetrating force of the injection becomes small. Thus, as shown in FIG. 8A and FIG. 8B, in the partial lift injection in which the needle lift amount is relatively small, the fuel can be injected such that fuel spray 50 only reaches the vicinity of the fuel injection valve 13 (remains in a region in the vicinity of and below the intake valve 15). Meanwhile, in the full lift injection, the fuel can be injected such that fuel spray 51 reaches the in-cylinder region on the exhaust side.

As described above, the injection axis faces the center of the cylinder on the plane that is orthogonal to the cylinder center axis C. On the plane that includes the injection hole 32 (the injection axis 46) and the cylinder, center axis C, the injection axis is parallel to the plane that is orthogonal to the cylinder center axis C, or slightly faces the piston 17. As described above, the injection hole 32 of the fuel injection valve 13 has the slit shape. As shown in FIG. 8A and FIG. 8B, the spray that is seen along the cylinder center axis spreads in a fan shape in the in-cylinder region. In the full lift injection or in the injection with the relatively large needle lift amount, the spray spreads to the in-cylinder region on the exhaust side. In the partial lift injection with the relatively small needle lift amount, the spray remains in the vicinity of the intake valve.

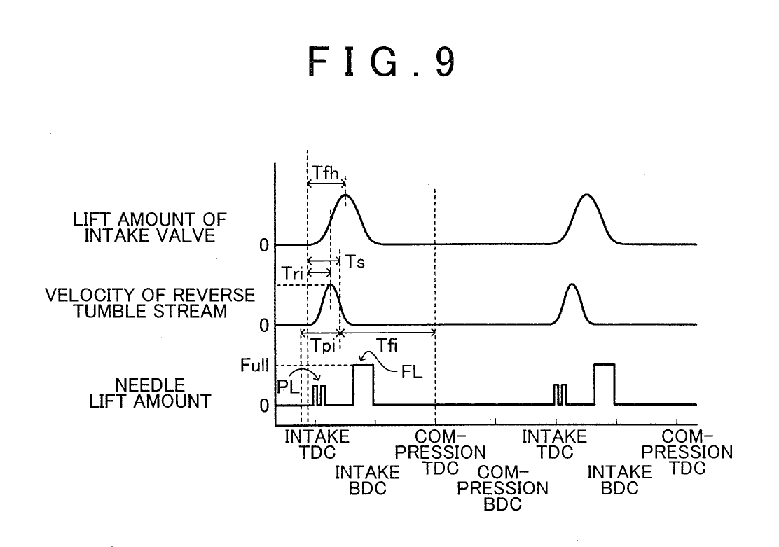

Next, fuel injection control of the first embodiment will be described. The ECU 90 can execute the main fuel injection and the auxiliary fuel injection. In the main fuel injection, the injection is executed once in a state that the needle lift amount is the first lift amount. In the auxiliary fuel injection, the injection is executed once in a state that the needle lift amount is the second lift amount. In this embodiment, as shown in FIG. 9, auxiliary fuel injection PL is executed for plural times (twice in an illustrated example) at arbitrary timing in an auxiliary fuel injection execution period Tpi, and main fuel injection FL is executed once at arbitrary timing in a main fuel injection execution period Tfi. In FIG. 9, Tfh indicates a period from a point in time at which the lift amount of the intake valve is zero to a point in time at which the lift amount of the intake valve becomes the maximum, Tri indicates a period from a point in time at which intensity of the reverse tumble stream is zero to a point in time at which the intensity of the reverse tumble stream becomes the maximum, and Ts indicates a period in which the reverse tumble stream is more intense than the normal tumble stream.

As shown in FIG. 5B, the auxiliary fuel injection execution period Tpi is a period that corresponds to a no-tumble period Tb and the reverse tumble period Ts. The no-tumble period Tb is a period from a point in time immediately before the intake valve 15 starts opening (a specified time before opening timing) to a point in time at which the intake valve 15 starts opening, and is also a period in which neither the reverse tumble stream nor the normal tumble stream is generated in the cylinder. The reverse tumble period Ts is a period after the intake valve 15 starts opening and in which the velocity (the initial velocity) of the reverse tumble stream is higher than the velocity (the initial velocity) of the normal tumble stream. That is, the auxiliary fuel injection execution period Tpi is a particular period that includes the timing at which the intake valve 15 starts opening. In other words, the auxiliary fuel injection execution period Tpi is a period from a point in time before the timing at which the intake valve starts, opening for a first specified time to a point in time after the timing at which the intake valve starts opening for a second specified time. The main fuel injection execution period Tfi is a period from the end of the reverse tumble period Ts to ignition timing (preferably, to the intake bottom dead center). That is, in the main fuel injection execution period Tfi, the velocity of the normal tumble stream is higher than the velocity of the reverse tumble stream, and the normal tumble stream is generated.

As described above, according to this controller of the first embodiment, since the fuel has the small penetrating force in the auxiliary fuel injection, the fuel that is injected in the auxiliary fuel injection is not adhered to the bore wall surface 12aex on the exhaust side, but remains in the in-cylinder region on the intake side. In the first embodiment, the auxiliary fuel injection is executed in the auxiliary fuel injection execution period (that is, when the reverse tumble stream is generated or immediately before the reverse tumble stream is generated). Thus, the fuel in the auxiliary fuel injection is dispersed in the in-cylinder region on the intake side by the reverse tumble stream, and air-fuel mixture with high homogeneity is generated in this region.

Furthermore, as described above, since the needle lift amount is larger in the injection by the main fuel injection than in the injection by the auxiliary fuel injection, the injected fuel has the large the penetrating force and thus reaches the in-cylinder region on the exhaust side. In this embodiment, the main fuel injection is executed in the main fuel injection execution period (that is, when the normal tumble stream is more intense than the reverse tumble stream). Accordingly, the fuel in the main fuel injection is carried by the normal tumble stream and dispersed in the cylinder without being adhered to the bore wall surface 12aex on the exhaust side.

Thus, according to the first embodiment, the air-fuel mixture with high homogeneity is generated in the combustion chamber 21 by both of the fuel in the auxiliary fuel injection that is dispersed by the reverse tumble stream and the fuel in the main fuel injection that is dispersed by the normal tumble stream. Moreover, since the fuel is less likely to be adhered to the bore wall surface 12a, the emission can be improved when compared to the conventional emission.

Noted that, in the first embodiment, a target fuel injection amount for each time of the auxiliary fuel injection (hereinafter, a “target auxiliary fuel injection amount”) is set to a specified amount in advance. Furthermore, the number of execution of the auxiliary fuel injection is set to the specified number in advance. In addition, the target auxiliary fuel injection amount is preferably a fuel injection amount within a range in which a lower limit of the target auxiliary fuel injection amount is set to an injection amount by which a stabilized amount of the fuel is injected in the auxiliary fuel injection and in which an upper limit thereof is set to an injection amount by which the fuel in the auxiliary fuel injection has the penetrating force that is barely large enough so that the fuel is reliably carried by the reverse tumble stream.

Then, during an operation of the engine, an amount of the fuel that is required to achieve the target air-fuel ratio is calculated as a total target injection amount (that is, an amount of the fuel that should be injected from the fuel injection valve in one engine cycle) Qt on the basis of the intake amount (that is, an amount of the air suctioned into the cylinder) and the target air-fuel ratio. Then, a value that is obtained by multiplying a target auxiliary fuel injection amount Qp by the number of the auxiliary fuel injection N is subtracted from the total target injection amount Qt. Accordingly, a target fuel injection amount in the main fuel injection (hereinafter, a “target main fuel injection amount”) Qf is calculated (Qf=Qt−Qp×N).

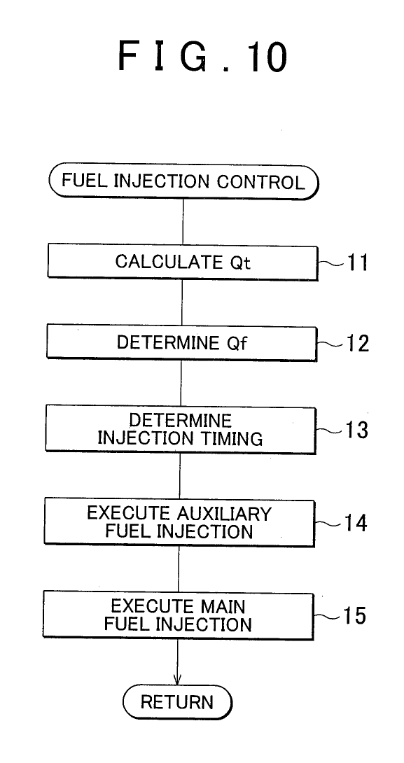

A description will be made on a fuel injection control flow in the first embodiment with reference to a flowchart of FIG. 10. A CPU of the ECU 90 executes a routine that is illustrated in the flowchart of FIG. 10 at a specified crank angle. Accordingly, a process in FIG. 10 is initiated at appropriate timing. First, in step 11, the total target injection amount Qt is calculated on the basis of the intake amount and the target air-fuel ratio. Next, in step 12, the target main fuel injection amount Qf is calculated on the basis of the total target injection amount Qt, the number of the auxiliary fuel injection N, and target auxiliary fuel injection amount Qp. Then, in step 13, injection timing of the main fuel injection and that of the auxiliary fuel injection are determined. Next, in step 14, the auxiliary fuel injection is executed when the injection timing of the auxiliary fuel injection comes. Then, in step 15, when the injection timing of the main fuel injection comes, the main fuel injection is executed, and this routine is terminated.

Next, a second embodiment will be described. As described above, the execution timing of the auxiliary fuel injection may be any timing as long as it is timing in the auxiliary fuel injection execution period (the specified period) Tpi. However, it is advantageous to set the execution timing of the auxiliary fuel injection in a specified period that is from “a point in time at which the intake valve 15 starts opening (a first point in time)” to “a point in time at which the lift amount of the intake valve 15 reaches the maximum lift amount of the intake valve 15 (a second point in time)” and that includes an intermediate point in time Trp between the first point in time to the second point in time.

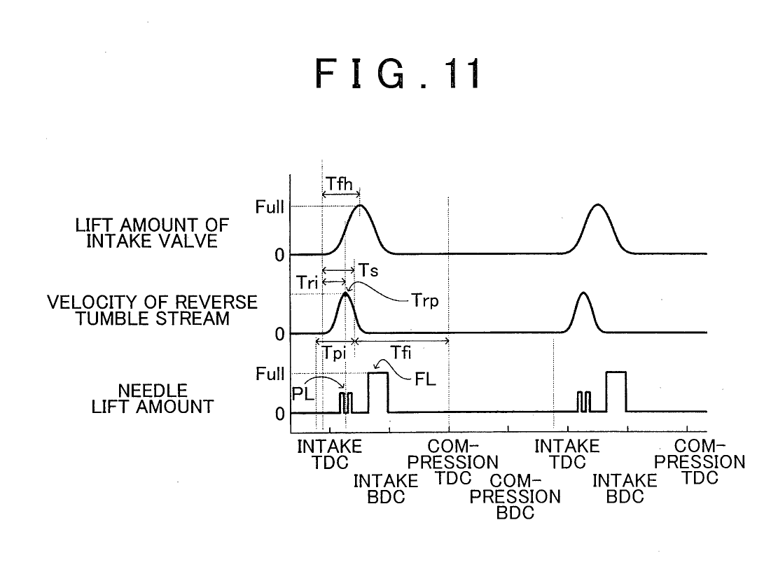

In other words, as shown in FIG. 5B, the velocity Vrt of the reverse tumble stream RT starts increasing after the intake valve 15 starts opening, and becomes the maximum velocity at the intermediate point in time Trp between the point in time at which the intake valve 15 starts opening and a point in time at which the lift amount of the intake valve 15 becomes the maximum lift amount. Thus, as shown in FIG. 11, a fuel injection controller of the second embodiment executes the auxiliary fuel injection in a specified period that is from the first point in time to the second point in time and that further includes the intermediate point in time Trp. In this way, since the injected fuel in the auxiliary fuel injection is carried by the reverse tumble stream whose intensity is substantially the highest, dispersion of the fuel is further promoted.

Next, a third embodiment will be described. When the engine speed is high, the tumble streams in the cylinder (the normal tumble stream and the reverse tumble stream) are intense. Thus, the injected fuel into the cylinder is rapidly dispersed. On the other hand, when the engine speed is low, the in-cylinder air streams are gentle, and the injected fuel into the cylinder is slowly dispersed. Thus, the homogeneity of the air-fuel mixture in the cylinder is deteriorated in comparison with that when the engine speed is high. Particularly, when the normal tumble stream is gentle, the spray of the fuel in the main fuel injection is eccentrically dispersed in the in-cylinder region on the exhaust valve side. Accordingly, a total value of the fuel that is injected in the auxiliary fuel injection (a total auxiliary fuel injection amount) is preferably increased with the reduction in the engine speed. In view of the above, in addition to the fuel injection control in the first embodiment (or the second embodiment), a fuel injection controller of the third embodiment executes control in which the number of the auxiliary fuel injection is increased with the reduction in the engine speed, so as to increase the total auxiliary fuel injection amount.

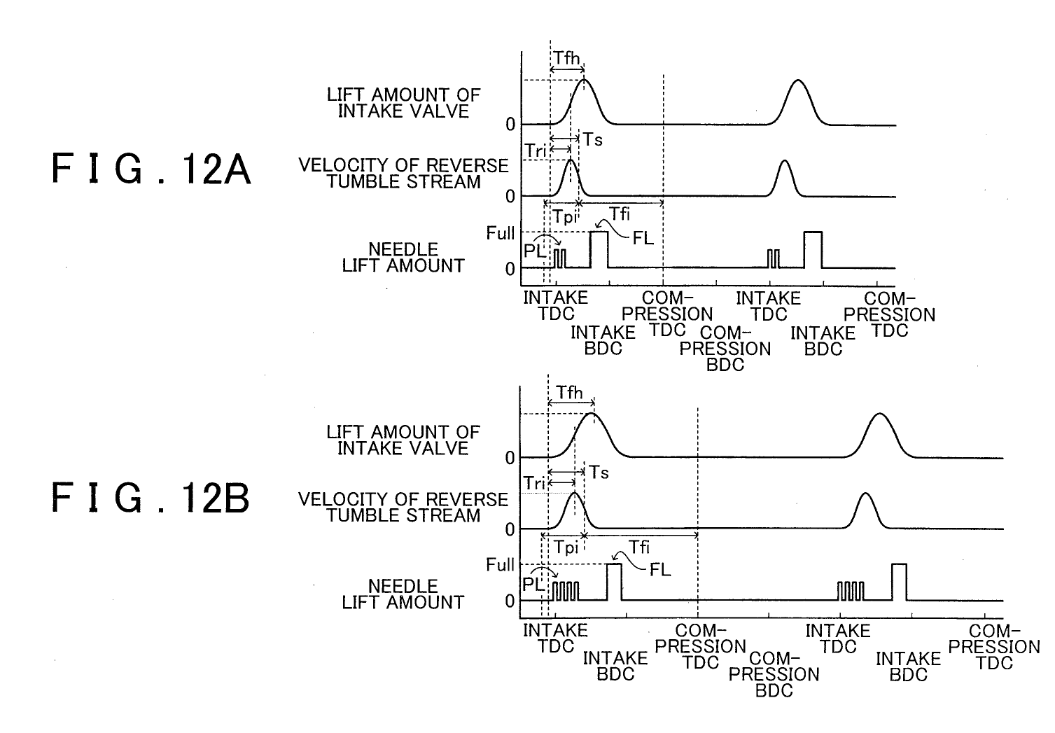

In other words, as shown in FIG. 12A, according to the third embodiment, when the engine speed is high, the auxiliary fuel injection PL is executed twice. Meanwhile, as shown in FIG. 12B, when the engine speed is low, the auxiliary fuel injection PL is executed four times. Here, the target auxiliary fuel injection amount for each time in the third embodiment is a constant value regardless of a magnitude of the engine speed.

According to the third embodiment, when the engine speed is low, the amount of the fuel in the main fuel injection is reduced and is compensated by an increase in the amount of the fuel in the auxiliary fuel injection. Accordingly, the amount of the fuel that is dispersed by the reverse tumble stream is increased. Thus, even when the engine speed is low, the air-fuel mixture with high homogeneity is generated in the cylinder. Furthermore, when the normal tumble stream is gentle due to the low engine speed, the amount of the fuel that has the large penetrating force and is injected in the main fuel injection is reduced. Accordingly, the amount of the fuel that is adhered to the bore wall surface 12aex on the exhaust valve side can be reduced. Noted that the target auxiliary fuel injection amount for each time in the third embodiment may be reduced and the number of execution of the auxiliary fuel injection may be increased with the reduction in the engine speed, so as to increase the amount of the fuel that is injected in the auxiliary fuel injection.

Furthermore, when the engine load is large, the total target injection amount is increased. Accordingly, when a ratio of the target main fuel injection amount to the total target injection amount remains the same, a main fuel injection amount is increased. As described above, the spray of the fuel in the main fuel injection has the large penetrating force. Accordingly, when the fuel injection amount in the main fuel injection is increased, the large amount of the fuel is eccentrically dispersed in the in-cylinder region on the exhaust side, and thus vaporization and dispersion of the fuel may not sufficiently be conducted. For this reason, it is preferred that the fuel injection amount in the auxiliary fuel injection is increased with the larger engine load. In view of the above, in the third embodiment, the number of the auxiliary fuel injection is set such that the number of the auxiliary fuel injection is increased with the larger engine load. Here, the target auxiliary fuel injection amount for each time in this case is a constant value regardless of the magnitude of the engine speed.

According to the above, when the engine load is large, the amount of the fuel in the main fuel injection is reduced, and is compensated by the increase in the amount of the fuel in the auxiliary fuel injection. Accordingly, the amount of the fuel that is dispersed by the reverse tumble stream is increased. Thus, even when the engine load is large, the air-fuel mixture with high homogeneity is generated in the cylinder.

Furthermore, when an engine speed NE is high, the in-cylinder air stream is intense, and the injected fuel is rapidly dispersed. Thus, even when the auxiliary fuel injection is not executed but only the main fuel injection is executed, the fuel in the main fuel injection is sufficiently dispersed. Furthermore, when the engine speed NE is high, the reverse tumble period is short. Thus, even when the auxiliary fuel injection is executed, the auxiliary fuel injection may not be completed in the reverse tumble period.

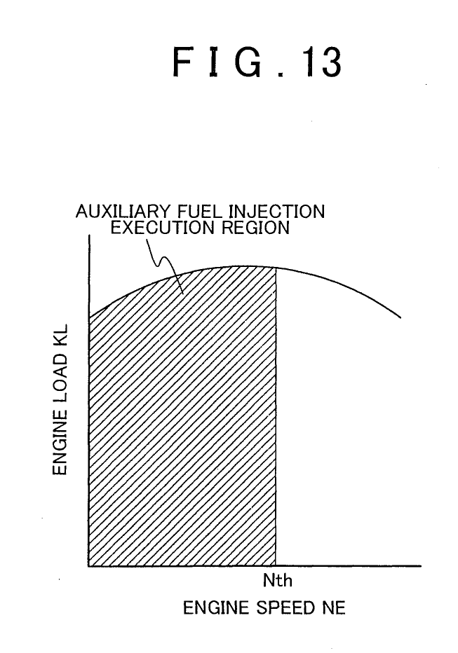

In view of the above, as shown in FIG. 13, even when the auxiliary fuel injection is not executed but only the main fuel injection is executed, a lower limit threshold NEth of the engine speed NE is set in advance, threshold NEth being a threshold at which the homogeneity of the air-fuel mixture is sufficiently increased. When the engine speed NE is equal to or lower than this threshold value NEth, both of the auxiliary fuel injection and the main fuel injection may be executed. Meanwhile, when the engine speed NE is higher than the threshold NEth, only the main fuel injection may be executed.

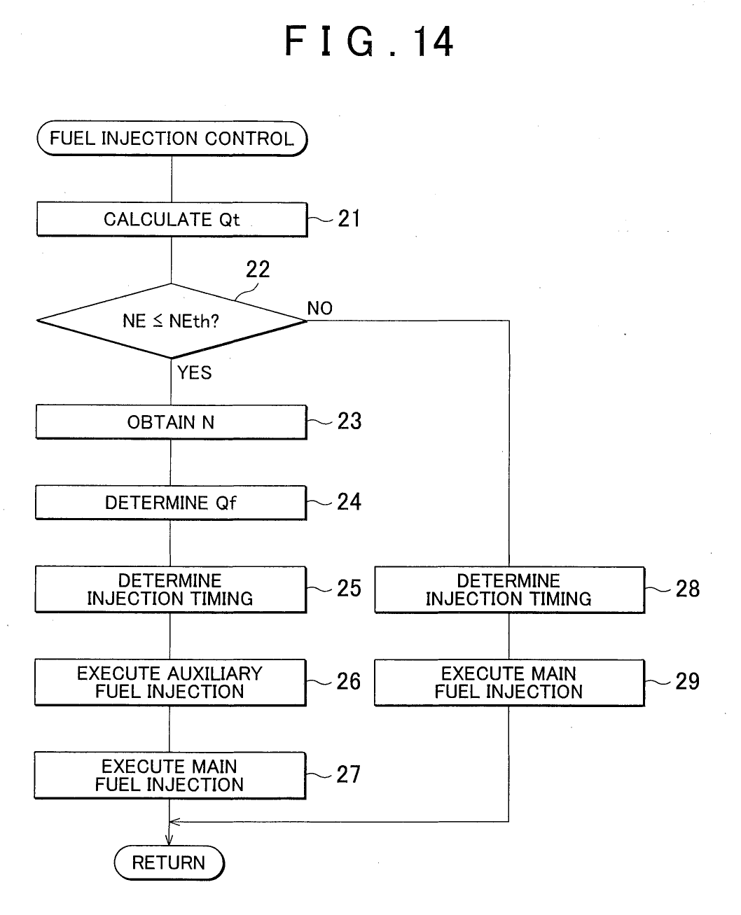

A description will be made on a fuel injection control flow of the third embodiment with reference to a flowchart of FIG. 14. Since step 21 and step 24 to step 27 in FIG. 14 are respectively the same as step 11 and step 12 to step 15 in FIG. 10, the description of these steps will not be made. The CPU of the ECU 90 executes a routine that is illustrated in the flowchart of FIG. 14 at the specified crank angle. Accordingly, a process in FIG. 14 is initiated at the appropriate timing.

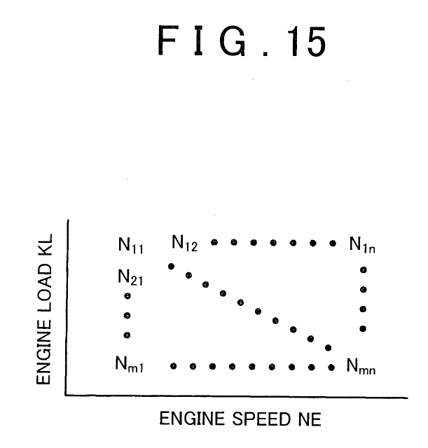

First, after the total target injection amount Qt is calculated in step 21, it is determined in step 22 whether the engine speed NE is equal to or lower than the threshold value NEth (NE≦NEth). That is, it is determined whether an execution condition of the auxiliary fuel injection is established. Here, if it is determined that NE≦NEth, in step 23, the number of the auxiliary fuel injection N that corresponds to the engine speed NE and an engine load KL is obtained from a map of FIG. 15. Next, the auxiliary fuel injection and the main fuel injection are executed in step 24 onward, and the routine is terminated. According to a lookup table of FIG. 15, the number of the auxiliary fuel injection N is determined such that the number of the auxiliary fuel injection N is increased with the lower engine speed NE and that the number of the auxiliary fuel injection N is increased with the higher engine load KL.

Meanwhile, if it is determined in step 22 that NE s NEth is not satisfied, in step 28, the injection timing of the main fuel injection is determined. Next, in step 29, the main fuel injection for injecting the fuel in the total target injection amount Qt is executed, and the routine is terminated.

As it has been described so far, according to the fuel injection controller according to each of the embodiments of the present invention, the fuel that is injected in the auxiliary fuel injection is dispersed by using the reverse tumble stream. Thus, the homogenous air-fuel mixture can be generated in the combustion chamber.

Furthermore, as described above, since the injection hole 32 of the fuel injection valve 13 is in the slit shape, the spray that is seen in the direction of the cylinder center axis C is in the fan shape (see FIG. 8A). The spray that is seen in the direction orthogonal to the plane including the center of the injection hole 32 and the cylinder center axis C is in the fan shape whose radiation angle is small (see FIG. 8B). Accordingly, compared to the case where the injection hole is in a cylindrical shape or a square cylindrical shape (that is, where the cross-sectional area of the injection hole 32 is constant), the fuel can easily remain in the vicinity of the intake valve 15 even when a further large amount of the fuel is injected in the auxiliary fuel injection. As a result, the further large amount of the fuel can be carried and dispersed by the reverse tumble stream.

Noted that, in each of the above embodiments, the exhaust valve 16 is closed before the intake valve 15 starts opening. However, mainly at the time of the large load, so-called valve overlap control may be executed, in which the intake valve 15 starts opening before the exhaust valve 16 is closed completely. However, even in such a case, any of the above embodiments can be applied. It is because, even when the auxiliary fuel injection, in which the needle lift amount is small, is executed either immediately before or immediately after the intake valve 15 starts opening during execution of the valve overlap control, the spray of the injected fuel remains in the in-cylinder region below the intake valve 15, and does not reach the air stream that is generated in the in-cylinder region on the exhaust side and flows out to the exhaust port 23.

In this case, the reverse tumble stream RT, which is generated immediately after the intake valve 15 starts opening, is generated before the exhaust valve 16 is closed completely, and can sufficiently disperse the spray that is injected to the in-cylinder region below the intake valve 15. It is because inertia of exhaust gas acts on the exhaust port 23 and an exhaust system that communicates with the exhaust port 23 and because there is no occurrence that the backflow of the exhaust gas from the exhaust port 23 to the cylinder causes the air to flow from the intake port 22 into the cylinder and thus suppresses the generation of the reverse tumble stream RT.

The present invention is not limited to the above embodiments, but various modifications can be adopted within the range of the present invention. For example, the fuel injection valve may be a fuel injection valve of a type other than the exemplified type (such as a fuel injection valve of piezo type). Furthermore, the injection hole of the fuel injection valve may be in a shape other than the exemplified shape. In addition, the intake port and the exhaust port of the internal combustion engine are not limited to the exemplified ones, two each of which are provided in the each cylinder. Moreover, each of the intake valve and the exhaust valve may be of a type other than the type that is driven by the rotation of the cam. At least one of the opening period of the intake valve and the opening period of the exhaust valve may be adjusted by a well-known valve timing adjustment mechanism, and the maximum lift amount of the intake valve may be adjusted by a well-known lift amount adjustment device. Each of the main fuel injection and the auxiliary fuel injection may be executed for plural times in the one engine cycle (a period in which each of intake, compression, combustion, and exhaust strokes are executed in one cylinder). In addition to the in-cylinder injection valve, the present invention can also be applied to an internal combustion engine that also includes a port injection valve for injecting the fuel into the intake port.

What is claimed is:

1. A fuel injection controller for an internal combustion engine, the internal combustion engine including a combustion chamber, an intake valve, an exhaust valve, and a fuel injection valve, the combustion chamber being defined by a piston crown surface, a cylinder head lower surface that faces the piston crown surface, and a cylinder bore, the intake valve configured to open or close a intake communicating section between the combustion chamber and an intake port, the intake communicating section arranged below the cylinder head lower surface, the exhaust valve configured to open or close a exhaust communicating section between the combustion chamber and an exhaust port, the exhaust communicating section arranged below the cylinder head lower surface, the fuel injection valve configured to inject fuel from a specified position in a region near a wall surface of the cylinder bore on the intake valve side to a region between the exhaust valve and the piston crown surface in the combustion chamber, the intake port configured to generate a normal tumble stream and a reverse tumble stream in an opening period of the intake valve, the normal tumble stream being an air stream that flows from the intake port into the combustion chamber, flows toward the region in the vicinity of the exhaust valve, further flows along the wall surface of the cylinder bore on the exhaust valve side toward the piston crown surface, and then flows from the piston crown surface toward the cylinder head lower surface, and the reverse tumble stream being an air stream that flows from the intake port into the combustion chamber, flows along the wall surface of the cylinder bore on the intake valve side toward the piston crown surface, and then flows from the piston crown surface toward the cylinder head lower surface, the fuel injection controller comprising:
an electronic control unit configured to:
(a) execute main fuel injection and auxiliary fuel injection in one engine cycle, a lift amount of a needle valve in the fuel injection valve is changed in a range up to a first lift amount in the main fuel injection, the lift amount of the needle valve is changed in a range up to a second lift amount that is smaller than the first lift amount in the auxiliary fuel injection; and
(b) execute the auxiliary fuel injection at least once in a particular period that includes timing at which the intake valve starts opening, so that fuel injected in the auxiliary fuel injection is carried by the reverse tumble stream.

2. The fuel injection controller according to claim 1 wherein the electronic control unit is configured to set the particular period within a period between a first point in time and a second point in time, the first point in time is timing at which the intake valve starts opening, the second point in time is timing at which the lift amount of the intake valve reaches a maximum lift amount of the intake valve, and the particular period includes an intermediate point in time between the first point in time and the second point in time.

3. The fuel injection controller according to claim 1 wherein the electronic control unit is configured to set the particular period such that the fuel injected in the auxiliary fuel injection is carried by the reverse tumble stream that is generated in a reverse tumble period in which an initial velocity of the reverse tumble stream is higher than an initial velocity of the normal tumble stream, and the electronic control unit is configured to execute the main fuel injection in a period that is after the reverse tumble period and in which the initial velocity of the reverse tumble stream is equal to or lower than the initial velocity of the normal tumble stream.

4. The fuel injection controller according to claim 1 wherein the electronic control unit is configured to execute the auxiliary fuel injection for plural times in the particular period.

5. The fuel injection controller according to claim 4 wherein the electronic control unit is configured to increase the number of execution of the auxiliary fuel injection as rotational speed of the internal combustion engine decreases.

6. The fuel injection controller according to claim 4 wherein the electronic control unit is configured to increase the number of execution of the auxiliary fuel injection as load of the internal combustion engine increases.
